(19) United States
(12) Patent Application Publication
(10) Pub. No.: US 2021/0031994 A1
(43) Pub. Date: Feb. 4, 2021

(54) TAMPER-PROOF SENSOR FOR A CONTAINER

(71) Applicant: VEGA Grieshaber KG, Wolfach (DE)

(72) Inventors: Levin DIETERLE, Oberwolfach (DE); Fabian WITT, Hofstetten (DE)

(21) Appl. No.: 16/942,561

(22) Filed: Jul. 29, 2020

(30) Foreign Application Priority Data
Jul. 30, 2019 (DE) 10 2019 211 326.5

(51) Int. Cl. B65D 55/02; B65D 41/62; B65D 41/04; G01C 9/02

(52) U.S. Cl. CPC B65D 55/028; G01C 9/02; B65D 41/04; B65D 41/62

(57) ABSTRACT

A tamper-proof sensor is adapted to be mounted on or in an opening of a container and to detect a process variable in a container. The sensor has a securing device which is designed to detect or prevent the sensor from being removed from the opening of the container.

### PRIORITY CLAIM

This application claims the benefit of the filing date of German Patent Application Serial No. 10 2019 211 326.5 filed on 30 Jul. 2020; the entire content of which is incorporated herein by reference.

### FIELD

The present disclosure relates to a tamper-proof sensor for mounting on or in an opening of a container and for detecting a process variable in a container, and a container lid.

### BACKGROUND

Sensors that record data or properties of process variables or substances inside a container are usually mounted outside the container on the container, or they are mounted inside the container and the container is tightly sealed after mounting so that the substance cannot escape from the container. For this reason, they are, for example, installed waterproof inside the container without access from the outside.

However, measuring instruments or sensors that are located in a sealed container cannot be mounted or dismounted easily and flexibly. Sensors that are located outside the container or partially inside the container have the disadvantage that the containers cannot be assembled in a space-saving manner.

In the distribution of chemicals, it is also advantageous if the transport container and the medium are not contaminated or soiled when the medium is removed. This means that the empty container can be refilled with the same medium by the distributor without any additional time-consuming and cost-intensive cleaning and can be delivered again. This is the case with the additive Adblue for diesel engines, for example.

In order to avoid contamination or to make manipulation visible, the lid of such a container is normally sealed and equipped with a closed withdrawal system.

If, in addition, a sensor/level sensor is to be used in a container opening by means of a screw-in thread, it must be ensured that this cannot be manipulated or that manipulation is evident, so that the container is cleaned or the complete container is replaced before the next filling.

### SUMMARY

The present disclosure relates to a sensor for detecting process variables in a container, which is configured in such a way that the sensor is protected against manipulation, or at least a manipulation of it is visible.

According to a first aspect, a tamper-proof sensor is provided, which is configured to be mounted on or in an opening of a container and to detect a process variable in a container. The sensor has a securing device to detect or prevent removal of the sensor. The securing device for preventing removal is designed, for example, such that the sensor, as explained below, is protected from outside access by its housing, or the housing has a lock, so that the sensor cannot be removed when the sensor is on or is attached in the opening of the container.

Here, a sensor is understood to be an arrangement which has an electronics unit with a component for the physical detection of the process variable, e.g. a physical sensor or a generator-receiver arrangement for e.g. ultrasonic waves or radar, as well as a power supply unit which provides at least the electrical power supply and which, depending on the application, electronically processes the recorded process variable, for example, and makes it available as digital data. The electronic elements that can be used for this purpose, such as voltage regulators, voltage converters, protective circuits, analog-digital converters, filters, amplifiers, microprocessors, memory modules, signal generators, vibration generators, radiators, piezo converters, etc. are known to the person skilled in the art. The electronics unit can have a housing, so that the electronics unit and the housing represent the sensor or part of the sensor. The sensor can also be equipped with elements for covering or closing the container, e.g. in order to close an opening of the container tightly.

According to one embodiment, the sensor has a container lid or is attached to a container lid which has a downward angled lateral edge with a first inner thread for screwing the container lid onto the container. The securing device is also an eyelet on the lateral edge of the container lid for attaching a seal. The sensor having the container lid can thus be removed in a tamper-proof way, or the sensor can be firmly attached to or in the container lid, and the container lid in turn can be screwed to the container in a tamper-proof way. Because the container lid can be secured by an eyelet with a seal on the edge of the container lid, manipulation such as the removal of the sensor or the container lid with the sensor attached can be detected optically.

The securing or protection device may thus consist of one or two parts. A first part is, for example, the eyelet for a seal, which secures the sensor if the sensor has the container lid or secures the entire arrangement of container lid and sensor if the sensor is mounted on or in a container lid. In the latter case, a second part of the protective device may ensure the removal of the sensor from the container lid.

Other embodiments of the container lid are possible. For example, the lid may have a different closing device instead of an inner thread, such as a snap closure, or the shape of the lid may be different. In any case, the container lid can be secured in the manner described above or in a similar way.

Ideally, the sensor has a geometrical housing form for the reception of a tool for unscrewing, which is located on the inside of the sealed container when installed. It is therefore not possible to remove the sensor from the outside of the container without breaking the seal. For example, the shape of the housing is hexagonal, so that a spanner or open-ended spanner can be used.

In an advantageous way, the sensor is flush with the outside of the container lid when installed, so that it does not offer a point of attack for a tool. This offers the further advantage that the corresponding containers are stackable, as no parts of the sensor or structures protrude to the outside.

According to an embodiment, the container lid has a structure on its underside which, for example, allows the sensor to be screwed on by means of additional screws, or which has a second inner thread, a bayonet lock, a snap-in device, or any other fastening to accommodate the sensor. Due to this structure, the sensor can be fixed from below to the container lid when the container is open, e.g. screwed on from below, or screwed or fixed into the container lid.

According to an embodiment, the container lid is closed at its upper side, so that in this embodiment the sensor can be screwed into the second thread from below, for example. In this case the container lid has no opening.

According to an alternative embodiment to the previous embodiment, the container lid has an e.g. circular opening. The radius of the opening corresponds to the radius of the housing of the electronics unit of the sensor, so that the sensor or housing can be screwed into the opening of the container lid. The housing has a shape that allows a tool to be inserted into the opening to screw the housing in from bottom to top. The housing also has a bulge on the side to stop the screwing in at a certain height, whereby the bulge is positioned at a height so that the upper side of the housing is level with the surface of the container lid when screwed in. So if the housing is screwed from below along the structure of the thread upwards, the bulge will stop the screwing in when the sensor is flush with the housing cover at the top.

According to another embodiment, the container lid has an opening with a radius of the housing for screwing in the housing, and the housing has a structure on its upper side for receiving a tool for screwing in the sensor or housing through the opening from top to bottom. In contrast to the previous version, the housing can thus be screwed into the opening from the outside. In order to prevent the housing from being unscrewed again unnoticed, the securing device has, according to another embodiment, a device on the structure with the second inner thread for receiving the housing, which is designed to prevent the housing from being unscrewed or to break visibly when the housing is unscrewed. In embodiment forms, the container lid has a structure on its underside with a second inner thread. A “second inner thread” here refers to the thread of the opening. A “first” inner thread as described above does not have to be present. For example, the container including its top is in one piece and therefore has only one opening with the “second” thread. In this case, the top of the container is also seen as the “container lid”.

According to one embodiment, the securing device has a safety cover cap that can be attached to the upper side of the housing, which can be screwed in from above through the opening of the container lid, and which is designed to break visibly when removed.

According to another embodiment, the sensor has one or more barbs along its circumference which are pressed against the housing wall of the sensor when screwed into the second thread provided for this purpose and are thus under mechanical tension. When the barbs have left the lower end of the screw-in thread again, they fold out again, so that a further unscrewing can be effectively prevented, similar to a cavity wall plug with a spring folding mechanism.

According to one embodiment, the sensor can be a level sensor for measuring a level of the medium in the container. The sensor can also be a sensor for determining substances or components of a medium, such as a liquid or gas in a container, or for detecting a temperature or pressure. As mentioned above, the sensor has an electronics unit for operating the sensor and providing the measured data, which is mounted in a housing. The housing accommodates the electronics unit, protects it against environmental influences and is particularly suitable for mounting on or in the container. The external thread on the sensor housing or on the housing of the electronics unit corresponding to the second thread can be screwed in to form a protruding contact surface, e.g. a circumferential projection on the end of the housing remaining outside the container. For example, the height of the protruding part may be such that it does not exceed an edge height on the top of the container, or the sum of the edge heights of the top and bottom of the container may not exceed the sum of the edge heights of the top and bottom of the container, so that the containers can be stacked. If the sensor is screwed in from below or integrated in the container lid, the upper side of the container lid including the sensor is flat.

On the contact surface towards the container, a sealing arrangement, e.g. a sealing ring, encloses the threaded shaft at the end of the thread. Preferably, the shaft part which is enclosed by the sealing arrangement can be threadless. When the sensor is screwed in from above, the sealing ring is pressed against the edge of the container opening so that the container is sealed. The sealing arrangement thus comprises, for example, a sealing ring which, when the measuring instrument is mounted, runs along the, for example, circular container opening and seals the container. The plane of the sealing arrangement in this case is the circular plane of the sealing ring adjacent to the circular opening. The term “below” can be seen here in the reference system of the measuring instrument, in which the direction “downwards” points into the container perpendicular to the container opening when mounted. Thus, if the sensor is mounted on the container lid, this means that the part “below” a geometric plane of the seal arrangement is located inside the container.

If the sensor is screwed in from below, the sealing ring lies on the bulge at the top and is pressed against the inner thread of the container or the container lid opening when screwed in.

The container has an external thread corresponding to the first inner thread so that the container lid can be screwed on. The container is sealed by a sealing arrangement, e.g. a sealing ring which is pressed against the upper edge of the container when the container lid is screwed on. The container also has an eyelet, so that a seal can be passed through this eyelet and the eyelet of the container lid, and the container can be sealed with the container lid and the sensor.

### BRIEF DESCRIPTION OF DRAWINGS

In the following, examples of the disclosure are described in detail with reference to the enclosed figures. Neither the description nor the figures shall be interpreted as restricting the disclosure.

FIG. 1 shows a first example with one sensor with the top of the container lid closed,

FIG. 2 shows a second example with a sensor with a closed housing that is integrally connected to the container lid,

FIG. 3 shows a third example of a sensor with an open top of the container lid for screwing in the sensor from below,

FIG. 4 shows a fourth example of a sensor with an open top of the container lid for screwing in the sensor from above,

FIG. 5 shows a fifth example of a sensor with a cover cap,

FIGS. 6a and 6b show a sixth example of a sensor with a barb.

The drawings are only schematic and not to scale. In principle, identical or similar parts are marked with the same reference marks.

### DETAILED DESCRIPTION

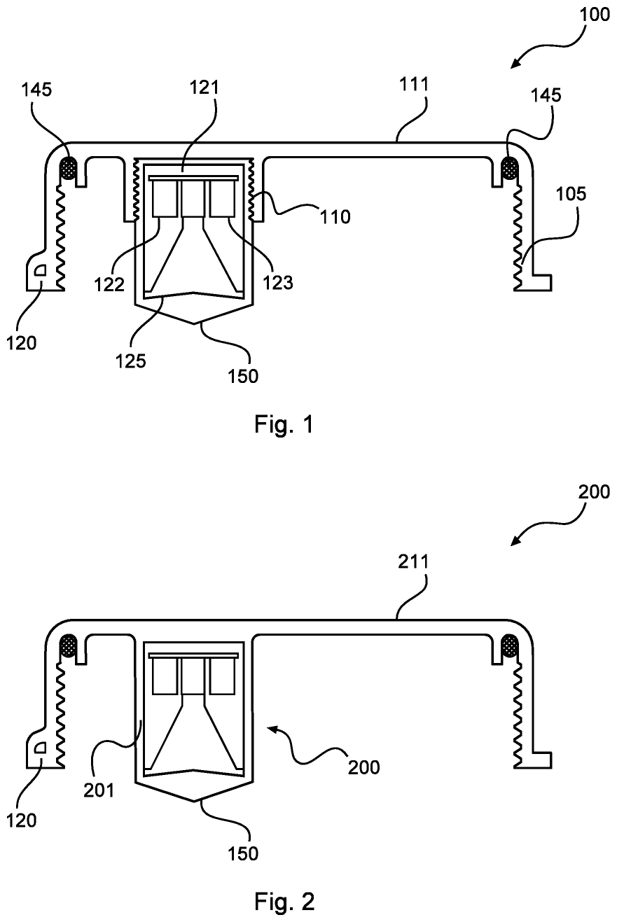

FIG. 1 shows in a first example of a sensor 100, for example a level sensor, which for example has a container lid 111 and an electronics unit comprising a radar sensor 121, a power supply unit 123, a communication unit 122 and an antenna 125. The electronics unit is surrounded by a housing 150. The housing 150 can be screwed from the inside by means of a structure, e.g. a thread 110, into a container lid 111, which can be secured with a seal through the eye 120. The sensor 100 with container lid 111 can be screwed onto the container together with the screwed-in electronics unit by means of a first thread 105, which is the container lid inner thread 105. The sealing of the lid 111 is achieved by the sealing arrangement 145, e.g. a sealing ring, which runs in a channel as shown in FIG. 1 and is pressed all the way round to the edge of the container when the lid 111 is screwed in. Since the lid 111 has no opening in the screw-in area of the housing 150, no additional seal is required there. After the lid 111 with screwed-in housing 150 has been screwed to the container and sealed, the sensor 100 and the housing 150 with the electronics unit cannot be removed from the container without breaking the seal. An opening of the container and thus a possible contamination of the container or the medium is also visible by breaking the seal.

FIG. 2 shows another example of a sensor 200, in which a sealable container lid 211 and the housing 150 with the electronics unit form a single unit. The housing 150 of the electronics unit 201 and the lid 211, for example, are made in one piece from high-density polyethylene (HDPE) by injection molding in conjunction with a joining process such as welding. In this example, the electronics unit 201 cannot be removed separately, but only together with the lid. However, opening the lid 111 including the electronics unit 201 can be detected by the seal.

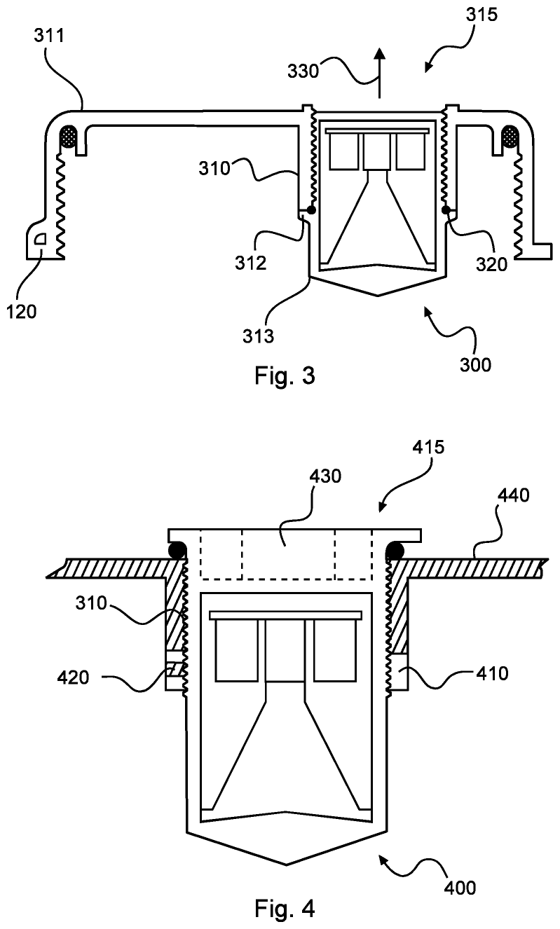

FIG. 3 shows a sensor 300 in a further example, which can be screwed into an opening 315 of a sealable lid 311 from the inside of the lid in the direction 330 shown. In the area of the outer diameter 313, the sensor 300 has a geometrical housing shape for this purpose to accommodate a tool (e.g. an outer hexagon) to facilitate screwing into the container lid 311. Due to a bulge 312 with an enlarged outer diameter 312 at the end of the thread, it is not possible to unscrew the sensor in direction to the outside of the container 330. The sealing ring 320 along the bulge 312 is pressed against the thread structure 310 when screwed in, so that the container can be closed tightly.

FIG. 4 shows a sensor 400 in a further example, in which the sensor top has a structure 430 for holding a tool. The tamper-proof sensor 400 can be screwed into a container opening 415 from the outside of the container 440 using a tool and secured against unscrewing by means of a locking device 410 on the inside of the container/lid. This can be a lock nut, for example, which can have an additional securing device such as a grub screw as clamping screw 420. This means that it is not possible to unscrew the sensor 400 from the outside of the container with a suitable tool, such as a 2-inch bunghole wrench, despite the correspondingly shaped housing with the structure 430.

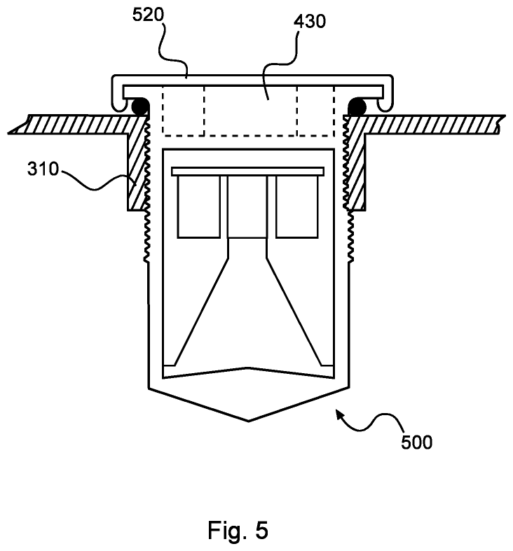

FIG. 5 shows a sensor 500 according to a further example, which has a correspondingly shaped housing with a structure 430 to accommodate a tool. A snap-on cover cap 520 or hood effectively prevents the attachment of a tool. Removing the cover cap will destroy it, so that it cannot be put back on. The cover cap 520 may, for example, have hooks that tear off when opening or removing the cover cap 520, or may be released via a predetermined breaking point. This means that any manipulation can be seen afterwards, so that appropriate measures can be taken.

Due to the presented sensor arrangement, it can be detected by the securing device according to the embodiment whether the container with the sensor has been unscrewed or whether the sensor has been screwed out of the container lid. In other embodiments, unscrewing the sensor from above or from the outside is prevented or access is completely prevented.

Due to the fact that the sensor can be screwed completely or almost completely into the container lid due to its shape, or does not or only slightly protrude at the top, or is even completely integrated into the container lid, it is possible that several containers can be stacked on top of each other, for example.

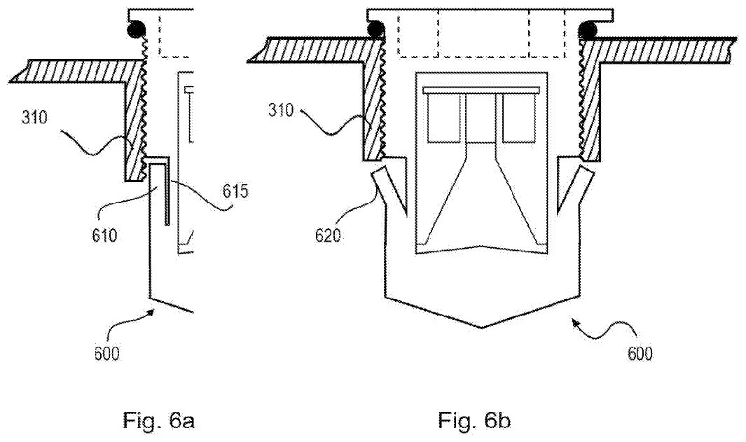

FIGS. 6a and 6b show a sensor 600 according to another example. While screwing into the thread 310 (FIG. 6a), one or more barbs 610, which are distributed along the circumference, are pressed against the outer housing wall 615 of the sensor. As soon as the sensor is completely screwed into the thread (FIG. 6b), the barbs, which are under mechanical tension, fold out of 620 and prevent them from being unscrewed again, similar to the spring folding mechanism of a cavity dowel.

This provides a tamper-proof sensor for detecting process variables in a container and a container lid, which are designed in such a way that manipulation is prevented or at least can be detected.

1. A tamper-proof sensor arrangement, comprising:
an electronics unit including:
a sensor configured to be mounted on or in an opening of a container, the sensor being configured to detect a process variable in the container and
a housing configured to house the sensor; and
a securing device configured to detect or prevent the sensor from being removed from the opening of the container.

2. The sensor arrangement of claim 1, wherein the electronics unit further includes:
a power supply unit providing electrical power supply to the electronics unit;
a communication unit; and
an antenna,
wherein the power supply unit, the communication unit, and the antenna are housed in the housing.

3. The sensor arrangement according to claim 1, further comprising:
a container lid having a downward angled lateral edge with a first inner thread configured to screw the container lid onto the container.

4. The sensor arrangement of claim 3, wherein the securing device is an eyelet on the lateral edge of the container lid, the eyelet being configured to permit a seal of the container to be passed therethough or attached thereto.

5. The sensor arrangement of claim 3, wherein the container lid includes a fastening arrangement on an underside thereof, the fastening arrangement configured to secure the housing thereto.

6. The sensor arrangement of claim 5, wherein the housing is attached to the fastening arrangement via a screw, a second inner thread, a bayonet lock, a snap-in device, or a further fastening arrangement.

7. The sensor arrangement of claim 5, wherein the container lid has an orifice extending from the underside to a surface thereof having a radius configured to insert a portion of the housing therein, the housing being configured to receive a tool to screw the housing through the orifice.

8. The sensor arrangement of claim 7, wherein the housing includes a bulge extending radially outward therefrom, the bugle positioned to prevent screwing of the housing into the orifice so that an upper side of the housing aligns with the surface of the container lid.

9. The sensor arrangement of claim 7, wherein the housing includes a structure extending radially outward from an upper side of the housing, the structure being configured to receive the tool to screw the housing through the orifice of the container lid into the fastening arrangement.

10. The sensor arrangement of claim 9, wherein the fastening arrangement includes a second inner thread.

11. The sensor arrangement of claim 5, wherein the securing device includes an arrangement on the fastening arrangement configured to receive the housing, the arrangement being adapted to prevent unscrewing of the housing or to break visibly when the housing is unscrewed.

12. The sensor arrangement of claim 7, wherein the securing device is a safety cover cap attached to an upper side of the housing above the orifice of the container lid and configured to break visibly when removed.

13. The sensor arrangement of claim 5, wherein the securing device includes at least one barb, the at least one barb configured to extend radially outward from the housing at a predetermined angle when the housing is completely screwed into the fastening arrangement.

14. The sensor arrangement of claim 3, wherein the container lid includes a sealing arrangement attaching the container lid to the opening of the container

15. The sensor arrangement of claim 3, wherein the housing is closed and integrally connected to the container lid.

16. The sensor arrangement of claim 1, wherein the sensor is a level sensor.
